(19) United States
(12) Patent Application Publication
(10) Pub. No.: US 2008/0271899 A1
(43) Pub. Date: Nov. 6, 2008

(54) Adjustable Inductive Heating Apparatus for Shoeing a Horse

(75) Inventors: Robert A. Kolonia, Milford, NJ (US); Kenneth M. Dillabough, Philadelphia, PA (US)

Correspondence Address: Michael G. Crilly, Esquire;Law Offices of Michael Crilly, 104 South York Road, Hatboro, PA, 19040, US

(73) Assignee: Robert A. Kolonia, Phillipsburg, NJ (US)

(21) Appl. No.: 12/113,712

(22) Filed: May 1, 2008

Related U.S. Application Data
(60) Provisional application No. 60/927,231, filed on May 2, 2007.

(51) Int. Cl. A01L 11/00; A01L 3/00

(52) U.S. Cl. 168/17; 168/45; 168/4

(57) ABSTRACT

An adjustable inductive shoeing apparatus including an inductive heating element, an adjustable mounting structure, and a control circuit is described. The inductive heating element is substantially U-shaped and disposed in a serpentine arrangement to replicate the U-shape of a horseshoe at least twice. The adjustable mounting structure supports and secures a horseshoe adjacent to the inductive heating coil so as to facilitate heating of the horseshoe and/or an adhesive. The adjustable mounting structure includes a pair of jaws and/or a plurality of brackets which are movable to conform to the lateral extents of a horseshoe. Brackets are disposed in a substantially U-shaped pattern along the adjustable mounting structure. In some embodiments, brackets contact the inductive heating element so as to adjust the inductive heating element to the shape and size of a horseshoe. In other embodiments, inductive heating element passes through the brackets. The control circuit controls the heating function of the inductive element. In some embodiments, a sensor measures the temperature of the horseshoe and/or adhesive to terminate heating at a pre-determined temperature.

### CROSS REFERENCE TO RELATED APPLICATIONS

This application is based upon and claims priority under 35 U.S.C. §119(e) from U.S. Provisional Application No. 60/927,231 filed May 2, 2007, entitled Inductive Heating Apparatus for Shoeing a Horse, the contents of which are hereby incorporated in their entirety by reference thereto.

### FEDERALLY SPONSORED RESEARCH AND DEVELOPMENT

None.

### BACKGROUND OF THE INVENTION

1. Field of the Invention

The instant invention generally relates to a device facilitating the attachment and detachment of a horseshoe via an adhesive composition rather than nails or the like. Specifically, the invention includes a U-shaped heating coil and mounting structure that conform to a variety of horseshoe sizes and shapes. The mounting structure holds the horseshoe in a controlled fashion so as to bond or de-bond the horseshoe to a hoof via an adhesive. The U-shaped heating coil minimizes the coupling distance between horseshoe and inductive element so as to maximize heating efficiency and to ensure uniform heating thereof.

2. Background

Horseshoes and shoeing methods practiced today evolved over at least two thousand years. Many historians believe the first attempt at an iron horseshoe was introduced between 500 and 600 B.C. By the first century A.D., the Romans made horseshoes composed of leather and metal, and referred to them as hipposandal. By the sixth century A.D., European horsemen nailed metal horseshoes to the hooves of horses. By the tenth century, cast bronze horseshoes with nail holes were common in Europe. By the thirteenth century, iron horseshoes were widely manufactured and sold. And by the sixteenth century, hot-shoeing, or the process of heating a horseshoe prior to placement on a hoof, was commonly practiced. After the sixteenth, little else changed in terms of the overall design of horseshoes and horseshoe nails and the shoeing of horses.

Recent innovations related to horseshoe design, including shoes comprised of polymers and composites, and alternate attachment methods, including adhesives rather than nails, have been widely resisted by farriers. Many innovators believe this resistance to modernity is rooted in a strong adherence to tradition, as well as misconceptions as to the limitations and risks of otherwise evolutionary improvements.

While nailing a horseshoe to a hoof is considered humane, it is not without risk. A typical hoof includes a sensitive inner structure surrounded by an insensitive outer structure. It is not uncommon for a nail to inadvertently penetrate the sensitive inner structure during shoeing, thus causing intense pain to a horse. Also, a nail can compromise the structure of a hoof, thus making shoe replacement problematic.

The application of adhesives in place of nails is likewise problematic. For example, the conditions and environment under which shoeing is performed do not allow a farrier to precisely and uniformly control the temperature along a horseshoe and adhesive layer so as to properly bond a shoe to and de-bond a shoe from a hoof. The failure to inadequately control temperature during the curing of an adhesive could result in a weakened or intermittent bond, thus allowing a shoe to be thrown during use and risking injury to a horse. The failure to inadequately control temperature during the de-bonding process could prevent removal of a shoe and/or adhesive from a hoof. Accordingly, the removal process could require cutting, sawing, and/or pulling a shoe and adhesive from a hoof, thereby risking injury and damage thereto. Furthermore, the attachment and detachment of a horseshoe via an adhesive must accommodate a variety of shoe shapes and sizes.

Accordingly, what is required is an apparatus facilitating the heating of a horseshoe and/or an adhesive layer in a controlled and uniform fashion so as to completely and uniformly bond a horseshoe to a hoof.

What is also required is an apparatus facilitating the heating of a horseshoe and/or an adhesive layer in a controlled and uniform fashion so as to completely and uniformly de-bond a horseshoe from a hoof.

What is also required is a heating method facilitating the rapid and uniform heating of an adhesive layer to its cure or degradation temperature for the purpose of shoeing a horse.

What is also required is an apparatus facilitating the placement, attachment, and detachment of a variety of horseshoe shapes and sizes via an adhesive.

### SUMMARY OF THE INVENTION

An object of the invention is to provide an adjustable apparatus facilitating the heating of a horseshoe and/or an adhesive layer in a controlled and uniform fashion so as to completely and uniformly bond a horseshoe to a hoof.

Another object of the invention is to provide an adjustable apparatus facilitating the heating of a horseshoe and/or an adhesive layer in a controlled and uniform fashion so as to completely and uniformly de-bond a horseshoe from a hoof.

Another object of the invention is to provide a heating method facilitating the rapid and uniform heating of an adhesive layer to its cure or degradation temperature for the purpose of shoeing a horse.

A further object of the invention is to provide an adjustable apparatus facilitating the placement, attachment, and detachment of a variety of horseshoe shapes and sizes via an adhesive.

One embodiment of the invention includes an inductive heating element, a mounting structure for supporting and securing a horseshoe adjacent to the inductive heating coil, and a control circuit facilitating the heating of the horseshoe and/or an adhesive by the inductive heating element. The mounting structure minimizing the coupling distance between the inductive heating element and horseshoe. The inductive heating element could include a flexible or rigid litz coil which is cooled via air or a fluid. In preferred embodiments, the inductive heating element approximates the shape of a horseshoe. The control circuit heats the horseshoe and/or adhesive to approximately the cure or degradation temperature of the adhesive. The control circuit applies heat to the horseshoe for a specified time or until a pre-determined temperature is achieved. In alternate embodiments, a temperature sensor measures the temperature of the horseshoe and/or adhesive to terminate heating at a pre-determined temperature. In yet other embodiments, the mounting structure is adjustable to the shape and size of a horseshoe.

By way of background, the efficiency of inductive heating is inversely proportional to the square of the distance between the inductive element or primary coil and horseshoe or secondary coil. The induction process causes a short circuit within the secondary coil inducing a temperature rise within the shoe. As such, the induction process does not require direct contact between the primary and secondary coils, thus avoiding wire connections between a power supply and the shoe. Wire connections are likely to cause a voltage drop, thus reducing the efficiency and practicality of direct heating. The instant invention minimizes the coupling distance between the inductive element and horseshoe so as to efficiently heat the horseshoe and establish a uniform coupling distance. Heat from the horseshoe is communicated to the adhesive so as to elevate the temperature therein to either the cure or degradation temperature of the adhesive. In other embodiments, the adhesive could include a metal fill so as to directly heat the adhesive with or without heat conduction from the horseshoe.

Furthermore, the invention could include a clamp and release mechanism allowing for the precise and controlled alignment and control of a horseshoe during the shoeing process. The primary coil could also include a flexible locking feature to accommodate a variety of horseshoe sizes and shapes.

Several advantages are offered by the described invention. The invention quickly, uniformly, repeatably, and safely heats a horseshoe and/or a curable adhesive, thereby bonding and de-bonding horseshoe and hoof. The invention is more humane than nails because it avoids injury and damage to the hoof of a horse. The invention minimizes the power requirements of the heating system by minimizing the distance between inductive element and horseshoe and inductive element and adhesive. The invention facilitates the heating of a variety of horseshoe sizes and shapes via a flexible U-shaped inductive structure. The invention facilitates the heating of a horseshoe without direct contact between inductive heating element and horseshoe, thereby avoiding wire leads and the like from directly contacting the horseshoe. The invention quickly heats a horseshoe to the bond or de-bonding temperature of an adhesive well before the time required for a horse to become restless during the shoeing process. The invention could be used to heat a horseshoe or the like so as to cauterize a hoof or to dry a hoof in contact with the horseshoe.

REFERENCE NUMERALS

| | |
|---|---|
| 1 | Horseshoe applicator |
| 2 | U-shaped heating coil |
| 3 | Mounting structure |
| 4 | Upper jaw |
| 5 | Lower Jaw |
| 6 | Switch |
| 7 | Plate |
| 8 | Guide |
| 9 | Slot |
| 10 | Bracket assembly |
| 11 | Flexible inductive element |
| 12 | Mounting hardware |
| 13 | Actuator |
| 14 | First end |
| 15 | Second end |
| 16 | Bracket assembly |
| 17 | Lead |
| 18 | Horseshoe |
| 19 | Hole |
| 20 | Post |
| 21 | Washer |
| 22 | Spring |
| 23 | Cap |
| 24 | Fastener |
| 25 | Lid |
| 26 | Coupling distance |
| 27 | Adhesive layer |
| 28 | Power Supply |
| 29 | Switch |
| 30 | Power Supply |
| 31 | Switch |
| 32 | Litz cable |
| 33 | Non-conductive tube |
| 34 | L-shaped bracket |
| 35 | U-shaped bracket |
| 36 | Cavity |
| 37 | Mounting hardware |
| 50 | Horseshoe applicator |
| 51 | Housing |
| 52 | Handle body |
| 53 | Control panel |
| 54 | Mode switch |
| 55 | Indicator light |
| 56 | Inductive unit |
| 57 | Reset button |
| 58 | Inductive cable |
| 59 | Sensor |
| 60 | Handle |
| 61 | Non-conductive plate |
| 62 | Non-conductive plate |
| 63 | Inductive element |
| 64 | Lower body |
| 65 | Movable jaw |
| 66 | Horseshoe |
| 67 | Spring assembly |
| 68 | Fixed jaw |
| 69 | Cavity |
| 70 | Controller |
| 71 | Inductive element |
| 72-80 | Step |

### BRIEF DESCRIPTION OF THE DRAWINGS

The invention will now be described in more detail, by way of example only, with reference to the accompanying drawings, in which:

FIG. 1 is a perspective view of the one embodiment of the instant invention showing a flexible, U-shaped inductive coil disposed on a mounting structure.

FIG. 2 is top plan view of the embodiment in FIG. 1 showing the U-shaped inductive coil contacting a support plate and disposed between a pair of movable jaws.

FIG. 3 is a side elevation view of the embodiment in FIG. 1 showing an actuator attached to a support plate and disposed opposite of a U-shaped inductive coil.

FIG. 4 is a bottom plan view of the embodiment in FIG. 1 showing bracket assemblies disposed within and moveable along slots within a support plate.

FIG. 5 is a perspective view with partial section view of an exemplary U-shaped induction element showing the placement and attachment of a flexible induction element within a bracket.

FIG. 6 is an exploded section view of an exemplary bracket assembly with holes disposed along an L-shaped bracket below a horseshoe.

FIG. 7 is a section view of an exemplary U-shaped bracket with holes disposed below and along the sides of a horseshoe.

FIG. 8 is a top plan view of the embodiment in FIG. 1 showing a horseshoe contacting a U-shaped inductive coil and secured between upper and lower jaws.

FIG. 9 is a block diagram showing an exemplary circuit design allowing control of the functional aspects of an actuator.

FIG. 10 is a block diagram showing an exemplary circuit design allowing the control of heating of a flexible inductive element.

FIG. 11 is a perspective view of another embodiment of the instant invention.

FIG. 12 is a side elevation view of the embodiment in FIG. 11 showing an inductive element disposed between a pair of non-conductive plates and between a handle and a pair of jaws.

FIG. 13 is a bottom plan view of the embodiment in FIG. 11 showing a horseshoe supported on a non-conductive plate above a conductive element and secured between a pair of jaws.

FIG. 14 is a section view of the handle body showing a cavity within which a spring assembly is housed that is attached at one end to a handle and at the other end to the handle body so that the handle opens and closes the movable jaw.

FIG. 15 is a block diagram of one exemplary arrangement showing connectivity between control circuitry, sensor, reset button, mode switch, induction unit, inductive element, and sensor.

FIG. 16 is a flowchart for an exemplary method of the instant invention.

### DETAILED DESCRIPTION OF THE INVENTION

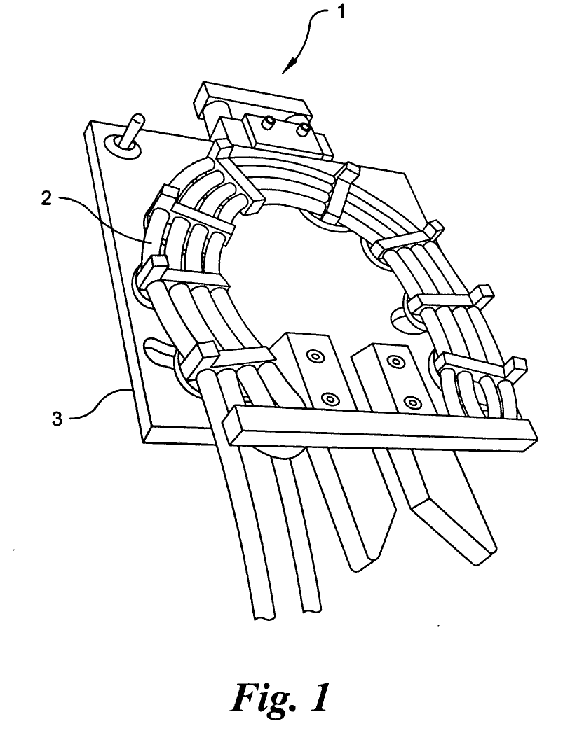

Referring now to FIG.1, one embodiment of the horseshoe applicator 1 is shown including a U-shaped heating coil 2 attached to a mounting structure 3. Horseshoes could include metal, polymer, composites, or combinations thereof, one example of the latter being the invention described by Kolonia, Sr. in U.S. Pat. No. 6,868,914.

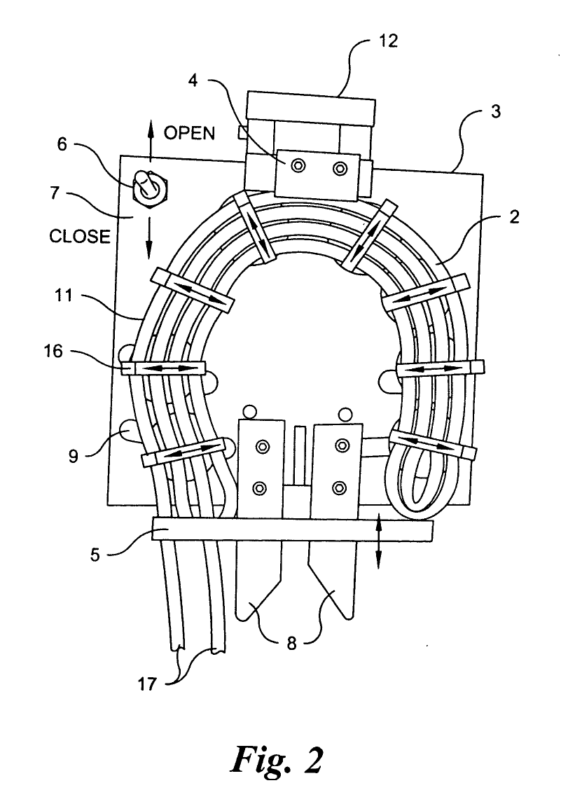

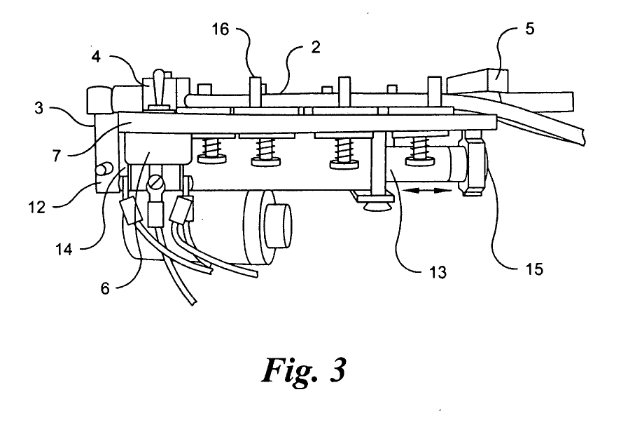

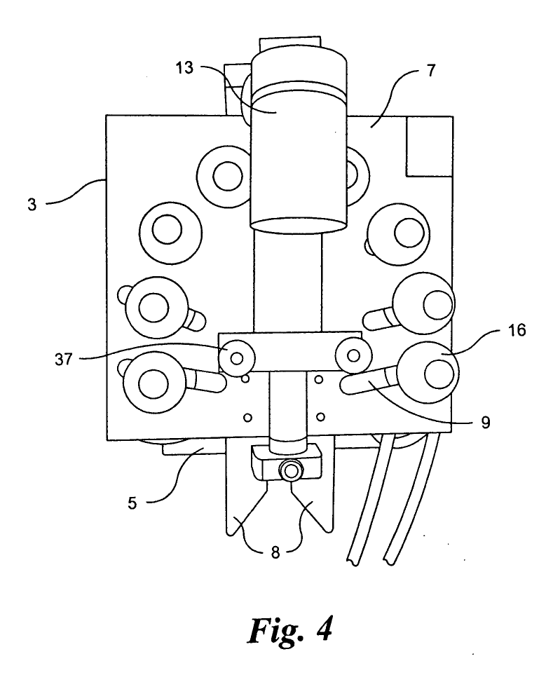

Referring now to FIGS. 2-4, the U-shaped heating coil 2 is comprised of at least one flexible inductive element 11 and a plurality of bracket assemblies 16. The flexible inductive element 11 is arranged in a serpentine-like fashion and thereafter bent to form a generally U-shape. The flexible inductive element 11 replicates the U-shape of a horseshoe at least twice. In FIG. 2, the flexible inductive element 11 is shown replicating the U-shape four times. Further, the inductive element 11 could include one or more conductors.

The mounting structure 3 includes a plate 7 of planar extent, an actuator 13 attached to an upper jaw 4 and a lower jaw 5, and a switch 6. The plate 7 could be mounted or built into a floor, platform, or the like or integrated into a handheld device. Actuator 13 and switch 6 are fastened to the plate 7 via methods understood in the art. For example, the actuator 13 could be attached to the plate 7 via mounting hardware 12, 37 and the switch 6 attached to the plate 7 via a nut.

A plurality of slots 9 are disposed along the plate 7 in a generally U-shaped pattern. Each slot 9 is oriented with its length inwardly disposed with respect to the U-shape. Each bracket assembly 16 resides within and is slidably disposed along a slot 9. The flexible inductive element 11 should be sufficiently resilient so as to allow positional adjusts to one or more bracket assemblies 16 while maintaining the U-shaped structure of the coil.

The actuator 13 could include a variety of push/pull force electromechanical devices, one example being a 12-volt device, part no. 6509-K2, sold my McMaster-Carr. The actuator 13 controls the opening and closing of the upper jaw 4 and lower jaw 5 which are disposed about the U-shaped heating coil 2. The upper jaw 4 is mechanically attached to the first end 14 of the actuator 13 via the mounting hardware 12 in a fixed arrangement with respect to the plate 7. A T-shaped lower jaw 5 is mechanically attached to the second end 15 or piston end of the actuator 13 in a movable arrangement with respect to the plate 7.

The actuator 13 is preferred to be aligned so that its extension length is parallel to the axis-of-symmetry of the U-shaped heating coil 2. Planar shaped guides 8 are mechanically fastened at one end of the plate 7 so as to extent therefrom. The lower jaw 5 is disposed between the guides 8 in a slidable fashion. Guides 8 and plate 7 are preferred to be composed of a non-conductive polymer or composite material. Upper jaw 4 and lower jaw 5 could be composed of a metal, non-conductive polymer, or composite.

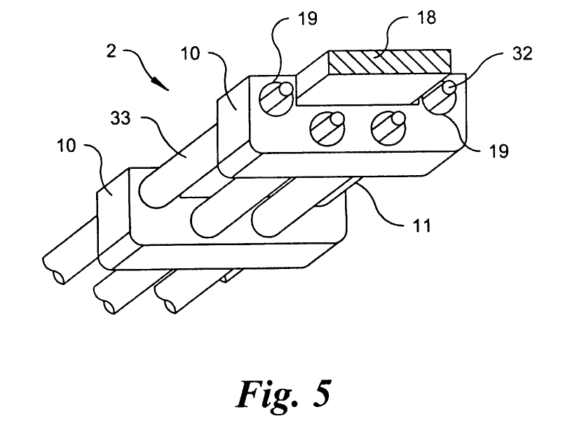

Referring now to FIG. 5, the flexible inductive element 11 is preferred to be composed of a litz cable 32 housed within a non-conductive tube 33. Exemplary

inductive elements are described by Haldeman in U.S. Pat. No. 5,461,215, which is incorporated in its entirety herein by reference thereto. The flexible inductive element 11 could be either fluid or gas cooled to avoid overheating. The flexible inductive element 11 passes through two or more bracket assemblies 10. Bracket assemblies 10 could include a variety of shapes including the U-shaped structure shown in FIG. 5.

A single flexible inductive element 11 is assembled with the bracket assemblies 10 so as to form a coil having two or more U-shaped layers which are disposed in a planar or generally planar fashion. The leads 17or ends of the flexible inductive element 11, as shown in FIG. 2, are attached to a commercially available power supply, which is understood in the art, capable of energizing the inductive element. Each bracket assembly 10 includes two or more holes 19 approximating the outer diameter of the non-conductive tube 33.

It is preferred for the flexible inductive element 11 to pass through and contact each bracket assembly 10. For example, each hole 19 could have a diameter less than that of the flexible inductive element 11 so as to grip the bracket assembly 10. In other embodiments, the flexible inductive element 11 could be attached to each bracket assembly 10 via an adhesive layer lining the interior surface of each hole 19. In yet other embodiments, each hole 19 could be sufficiently large so as to allow the bracket assembly 10 to slide along flexible inductive element 11.

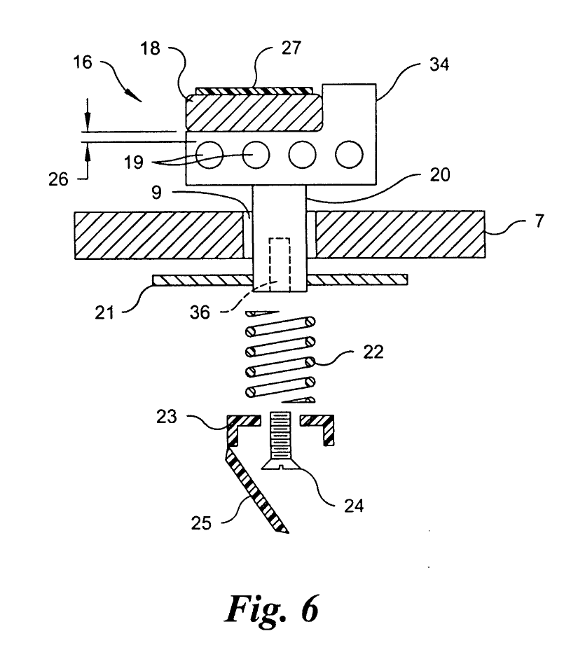

Referring now to FIG. 6, an exemplary bracket assembly 16 is shown including an L-shaped bracket 34, a post 20, a washer 21, a spring 22, a cap 23 with lid 25, and a fastener 24 assembled in the described order. The L-shaped bracket 34 provides a single positive stop to grip a horseshoe 18, preferably along the outer edge of the horseshoe 18. It is likewise possible to have a U-shaped bracket 35 so as to provide a positive stop on both sides of a horseshoe 18. A plurality of holes 19 are positioned along the horizontal and vertical extents of the L-shaped bracket 34. Both L-shaped bracket 34 and post 20 are preferred to be composed of a non-conductive material, preferably a polymer. The washer 21 is likewise preferred to be composed of a non-conductive material to electrically isolate the spring 22 and to facilitate sliding along the slot 9.

The post 20 could include a cylindrical shaped projection which is attached to or molded onto the L-shaped bracket 34 opposite of the contact surface for the horseshoe 18. It is preferred for each post 20 to have a width less than that of the slot 9 along the plate 7 so as to allow sliding motion therein.

During assembly, the post 20 is placed into the slot 9 so that it projects beyond the plate 7 opposite of the L-shaped bracket 34. A washer 21 is then placed onto the post 20. Next, a spring 22 is placed over the post 20. The cap 23 is then placed onto the spring 22 and a fastener 24, either a screw or bolt, is threaded into a cavity 36 within the end of the post 20. A lid 25, which could be hinged to the cap 23, is attached to the cap 23 to cover the fastener 24 within the cap 23. Attachment of lid 25 to cap 23 could be via a snap fit or adhesive bond.

The spring 22 applies a force onto the bracket assembly 16 so that it is pulled onto the plate 7, thereby maintaining its position along the plate 7 after adjustment. The user adjusts the location of the bracket assembly 16 by pushing on the lid 25 so that the L-shaped bracket 34 lifts up and freely slides from side to side along the slot 9. This arrangement ensures the brackets 35 are movable and conformable to the size and shape of a horseshoe.

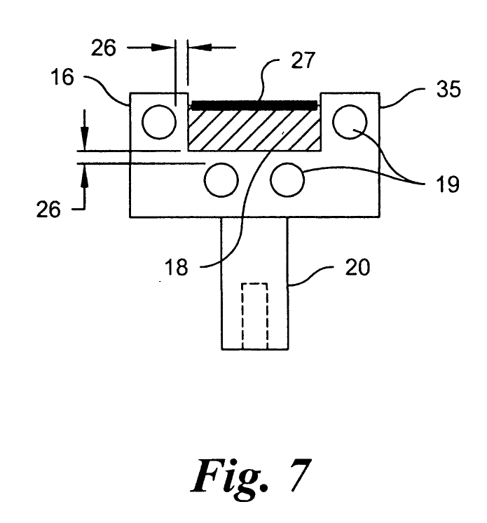

Referring now to FIGS. 6 and 7, both L-shaped brackets 34 and U-shaped brackets 35 are preferred to minimize the coupling distance 26 or the shortest distance between the circumference of a hole 19 and the surface of the horseshoe 18. It is likewise preferred for the coupling distance 26 to be uniform within and between bracket assemblies 16 so as to uniformly heat the horseshoe 18 and/or adhesive layer 27.

The adhesive layer 27 could be composed of a commercially available curable epoxy with or without a metal fill. Compositions having a metal fill, one example being stainless steel particulates, facilitate direct heating of the adhesive. Otherwise, the adhesive layer 27 is indirectly heated by first heating the horseshoe 18 with the flexible inductive element 11 and thereafter by conductive heating from the horseshoe 18 into the adhesive layer 27.

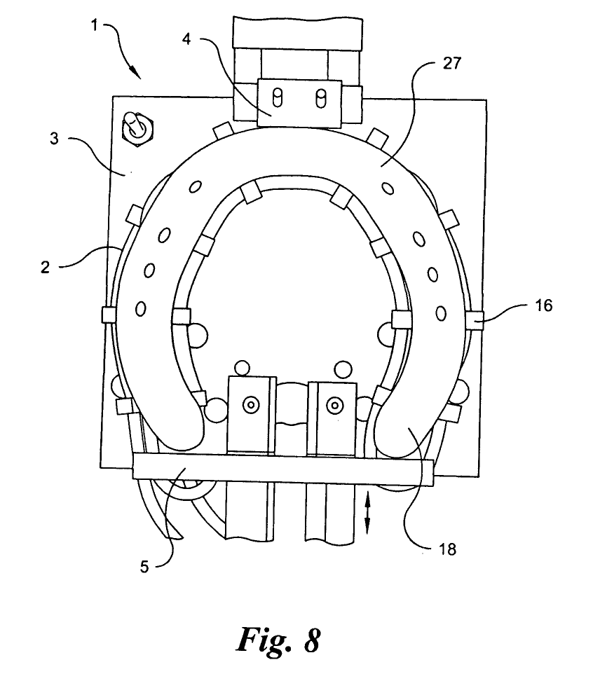

Referring now to FIG. 8, the shoeing process includes placing a horseshoe 18 onto a U-shaped heating coil 2. Next, the bracket assemblies 16 are adjusted to conform to the shape of the horseshoe 18 and the horseshoe 18 is grasped by retracting the upper jaw 4 and lowerjaw 5 onto the horseshoe 18. An adhesive layer 27 is applied onto the horseshoe 18 opposite of the U-shaped heating coil 2. The user next energizes the U-shaped heating coil 2 so as to inductively heat the adhesive layer 27 to a predetermined cure temperature, typically 200 to 300 degrees Fahrenheit for most epoxy compositions. Temperature within the horseshoe 18 and/or adhesive layer 27 could be measured via a thermocouple or the like. The heating event could be either time or temperature dependent. The user then releases the horseshoe 18 by extending the lower jaw 5 via the actuator 13 and pulling the horseshoe applicator 1 away from the horseshoe 18.

After the horseshoe 18 has exceeded its useful lifetime, the horseshoe applicator 1 is used to remove the horseshoe 18. The horseshoe applicator 1 is placed over the hoof so that the U-shaped heating coil 2 contacts the horseshoe 18. The user then adjusts one or more bracket assemblies 16 so that the U-shaped heating coil 2 conforms to the shape of the horseshoe 18. Next, the horseshoe 18 is grasped by closing the lower jaw 5 by retracting the piston within the actuator 13. The user next energizes the U-shaped heating coil 2 so as to inductively heat the adhesive layer 27 to a predetermined degradation temperature, typically 320 to 400 degrees Fahrenheit for most epoxy compositions, which de-bonds the horseshoe 18 from the hoof. The user then removes the horseshoe 18 by pulling the horseshoe applicator 1 away from the hoof.

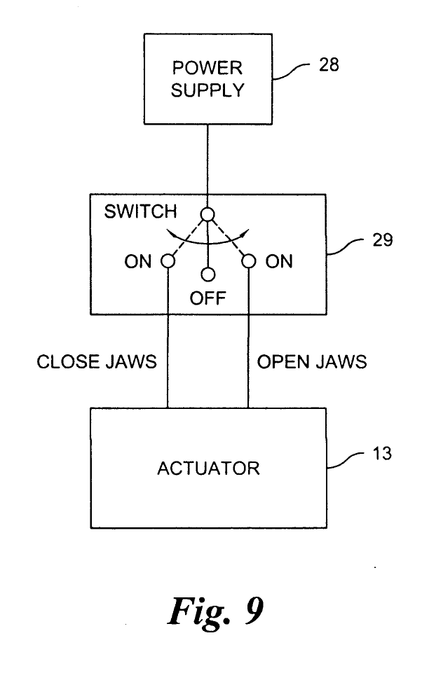

Referring now to FIG. 9, a block diagram describes an exemplary control circuit for the opening and closing of the upper jaw 4 and lower jaw 5 described above. A power supply 28 is electrically connected to a three-way switch 29. The power supply 28 could include a variety of commercial devices, one example being a 1-amp motorcycle battery charger, model no. MC-1, sold by Schumacher. Likewise, the switch 29 could include a variety of commercially available devices, one example being a double insulated toggle switch, model no. LR39146, 80000 SER 10A 250. Thereafter, the switch 29 is electrically connected to an actuator 13 having a retractable and extendable piston, as described above. The switch 29 is preferred to have one ON selection to extend the piston thereby opening the jaws, one ON selection to retract the piston thereby closing the jaws, and an OFF selection.

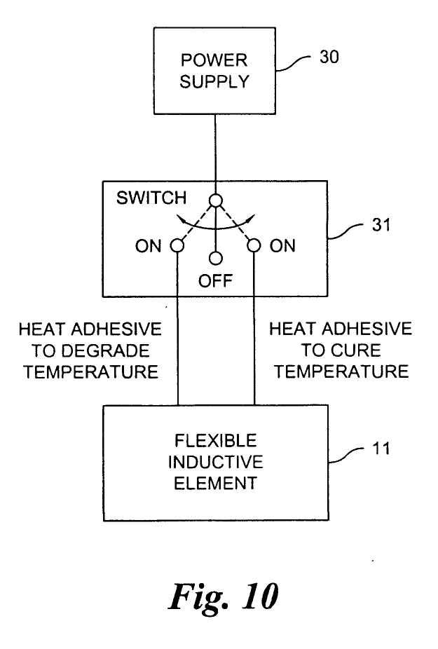

Referring now to FIG. 10, a block diagram describes an exemplary control circuit to drive an inductive coil so as to heat an adhesive to its cure or degradation temperature. A power supply 30 capable of electrically powering a flexible inductive element 11 is electrically connected to a three-way switch 31. Thereafter, the switch 31 is electrically connected to a flexible induction element 11, as described above. The switch 31 is preferred to have one ON selection to heat the adhesive to its cure temperature, one ON selection to heat the adhesive to its degradation temperature, and an OFF s election.

The time required to reach the bonding and de-bonding temperatures of an adhesive is extremely important to avoid agitating a horse. For example, tests performed with a current of 225 amps at 200 kHz heated a horseshoe to bonding and de-bonding temperatures in less than 90 seconds. This time is sufficient to allow a farrier to attach or detach a shoe from a hoof before the horse could become restless.

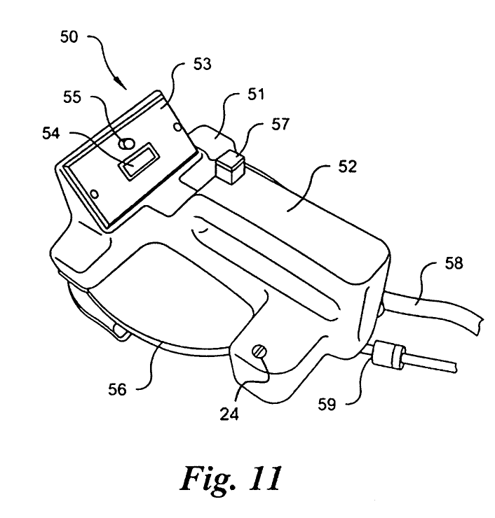

Referring now to FIGS. 11-13, an exemplary handheld embodiment of the horseshoe applicator 50 is described. The horseshoe applicator 50 includes an ergonomically designed housing 51 including a handle body 52 and a lower body 64 disposed about and attached to a generally planar inductive unit 56. The handle body 52 and lower body 64 could be composed of a polymer or composite which is electrically and thermally non-conductive. The handle body 52 is attached to the lower body 64 via one or more fasteners 24 or an adhesive.

The inductive unit 56 could be comprised of an inductive element 63 disposed between and attached to a pair of non-conductive plates 61, 62 and include the mounting structure 3 described above. The inductive unit 56 is secured at one end between the handle body 52 and the lower body 64 and could be further secured to the handle body 52 via fasteners or adhesive.

The inductive element 63 could be a flexible or rigid, U-shaped litz cable, as described above, either air or fluid cooled. The leads of the inductive element 63 could pass through an opening along the handle body 52 and thereafter connect to an inductive cable 58 which is connectable to an induction unit for power and cooling purposes.

The front end of the horseshoe applicator 50 could include a control panel 53 oriented at an oblique angle. The control panel 53 could include an indicator light 55 and a mode switch 54. A reset button 57 could be located on the handle body 52 to facilitate easy access by a user's thumb while grasping the handle body 52. The reset button 57, mode switch 54, and indicator light 55 could be electrically wired to control circuitry housed within the handle body 52. The mode switch 54 could include two or more functional selections including the installation of a shoe, removal of a shoe, and OFF. The installation selection would allow for the heating of shoe and/or adhesive to the cure temperature of the adhesive. The removal selection would allow for heating of shoe and/or adhesive to the degradation temperature of the adhesive.

In application, a user would select the desired functional mode via the mode switch 54 and activate the heating function by depressing the reset button 57. The indicator light 55 would light up and remain lit until the shoe and/or adhesive reaches the temperature which corresponds to the selected functional mode. Thereafter, the indicator light 55 would turn OFF so as to indicate to the user that the shoe is either bonded to or de-bonded from the hoof.

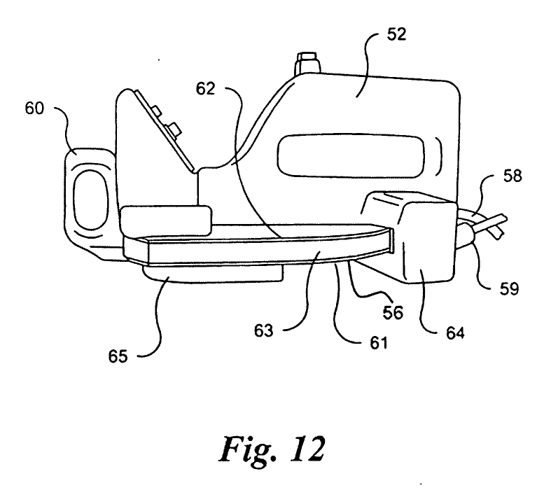

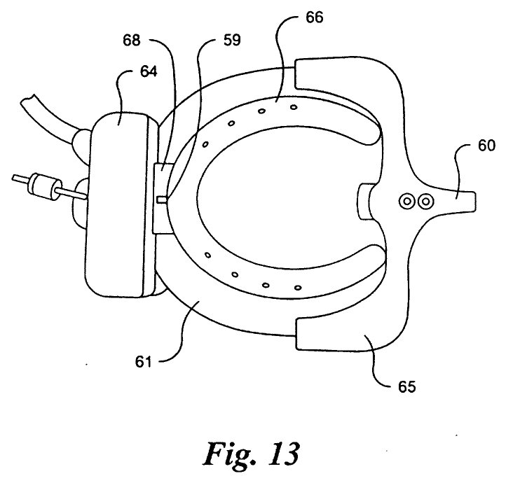

Referring again to FIG. 13, a horseshoe 66 is shown secured to the non-conductive plate 61 along the bottom of the horseshoe applicator 50. The means to secure the horseshoe 66 could include a paired and complimentary arrangement of a fixed jaw 68 and a movable jaw 65 which are conformable to the lateral extents of the horseshoe 66. The fixed jaw 68 could be comprised of a non-conductive material which is attached at one end to the lower body 64 and having a generally curved shaped at one end to approximate the curvature of the closed end of a horseshoe 66. The movable jaw 65 could be a generally U-shaped element to contact and accommodate the open end of a horseshoe 66. This arrangement ensures the mounting structure conforms to the side and shape of the horseshoe 66. The movable jaw 65 is preferred to contact the non-conductive plate 61 and to be slidable thereon along the axis-of-symmetry of the horseshoe 66. Further, the movable jaw 65 could include a handle 60 fixed at one end, as shown in FIG. 12, to facilitate movement of the movable jaw 65.

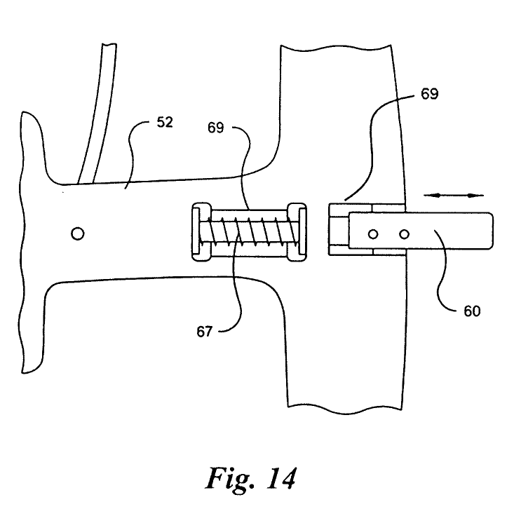

Referring now to FIG. 14, the handle body 52 is shown having a pair of cavities 69 disposed therein adjacent to the inductive unit 56. A spring assembly 67 resides within one cavity 69 and is attached at one or both ends thereof to the handle body 52. The other end of the spring assembly 67 is attached to the handle 60, which could partially reside within a second cavity 69. The movable jaw 65 is attached to the handle 60 above the non-conductive plate 61 so as to facilitate the coupled movement of movable jaw 65 and handle 60. The spring assembly 67 is preferred to pull the movable jaw 65 towards the fixed jaw 68 so that the distance between the two jaws is less than the length of a horseshoe 66. This arrangement ensures a compression fit between horseshoe 66 and fixed jaw 68 and movable jaw 65 when the horseshoe contacts the non-conductive plate 61. Further, the thickness of the non-conductive plate 61 is minimized to minimize the distance between the inductive element 63 and horseshoe 66.

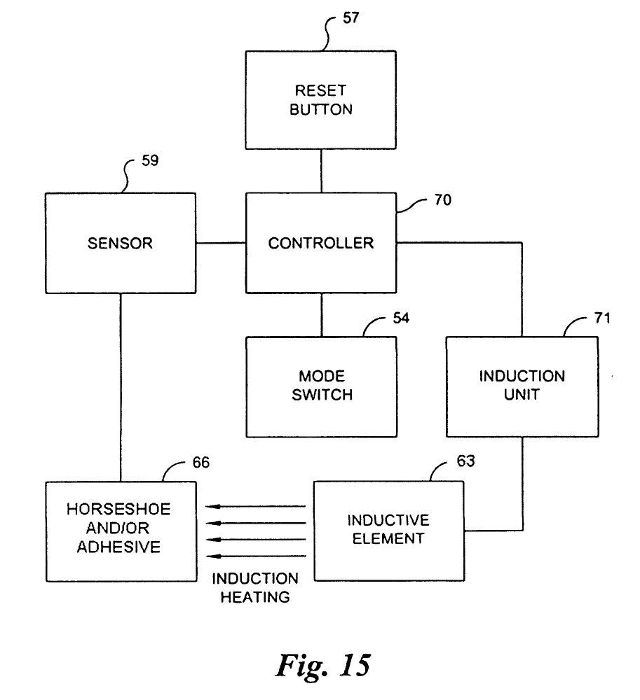

In preferred embodiments, a sensor 59 is used to measure temperature. The sensor 59 could include devices which directly or remotely measure temperature. For example, the sensor 59 could be attached to the handle body 52 or disposed along a cavity within the lower body 64 and fixed jaw 68 and fixedly attached thereto. The sensor 59 could be a thermocouple device, one example being model no. J28U-0004(⅝)-13A003(⅝)-6 sold by Pyromation, Inc. located in Fort Wayne, Ind. The tip of the sensor 59 is preferred to extend beyond the fixed jaw 58 so as to contact the horseshoe 66 when placed against the curved end of the fixed jaw 58, as represented in FIG. 13. In yet other embodiments, the sensor 59 could include an infrared or other device which is capable of measuring temperature without contact. The block diagram in FIG. 15 shows and describes one possible embodiment for the control of the applicators described above. A controller 70 could be attached to or communicate with a reset button 57, mode switch 54, inductive unit 71, inductive element 63, and optional sensor 59. An exemplary reset button 57 could be a commercially available push-type switch capable of ON/OFF functionality. The inductive unit 71 could be a commercially available device capable of powering and cooling an inductive element 63.

The reset button 57 is used to engage the induction unit 71 to power the inductive element 63 based upon the setting of the mode switch 54. An exemplary mode switch 54 could be a commercially available rocker-type device with two or more selections. The reset button 57 allows for one or more heating cycles by the inductive element 63 to the extent that the measured temperature does not exceed the threshold value of the selected mode.

The mode switch 54 allows the user to select the mode of operation of the applicator, namely, the attachment or detachment of a horseshoe 66. An indicator light 55, as described above, could be ON during the heating cycle and OFF after the threshold temperature is reached, as a visual queue to the user.

In some embodiments, the controller 70 could be a circuit which receives a temperature dependent voltage from a thermocouple-type sensor 59, representative of the temperature within the horseshoe 66 and/or adhesive. Exemplary controllers 70 include temperature control units sold by Chromalox, Inc. located in Pittsburgh, Pa. The controller 70 could terminate power from the induction unit 71 when the sensed temperature is more than the cure or degradation temperature of the adhesive system. In this approach, it is possible for the measured temperature to be more or less than the actual temperature within the adhesive layer.

In other embodiments, the controller 70 could be a commercially available timer circuit which allows function of the inductive elements 63, described herein, for a pre-determined time period. The controller 70 could terminate power from the induction unit 71 only after the inductive element 63 has functioned for the prescribed time period, representative of the cure or degradation temperature of the adhesive system.

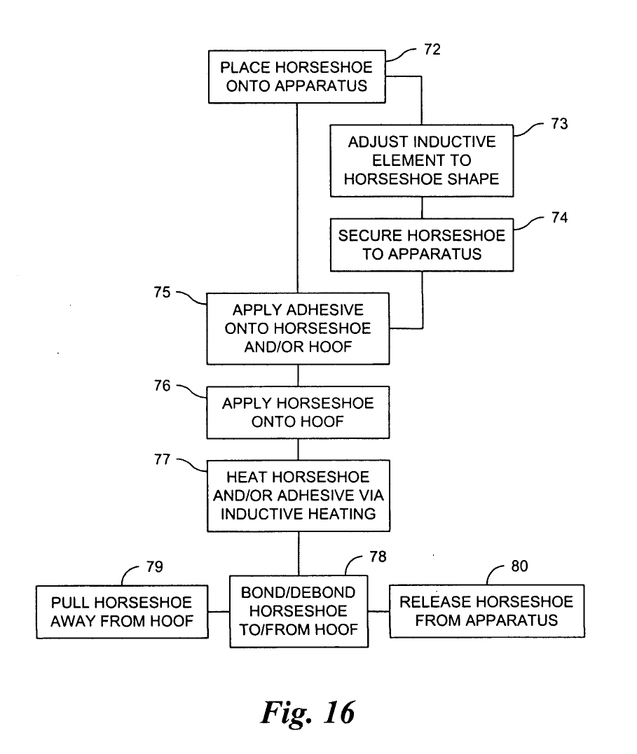

Referring now to FIG. 16, a flowchart describes the attachment and detachment methods for the instant invention.

The attachment method could include steps 72-78 and 80. In step 72, the user places a horseshoe onto one of the applicators described above. In some embodiments, the user could adjust the inductive element in step 73 to the size and shape of a horseshoe when the inductive element is flexible or of a non-rigid construction. It is likewise possible for the user in some embodiments to secure a horseshoe in step 74 to an applicator via brackets, jaws or the like. Further, the user may adjust the mounting structure to conform to the size and shape of a horseshoe. In step 75, the user then applies adhesive onto the horseshoe and/or hoof, which in some applications might require the cleaning or preparation of or application of a chemical onto the horseshoe and hoof surfaces. While a variety of adhesives are applicable to the instant invention, including one and two-part epoxies, an exemplary adhesive is Loctite® brand Adhesive # 392 which could include the application of one or more compositions to the hoof or shoe prior to application of the adhesive. In preferred embodiments, the adhesive should fill the nail holes along the horseshow. In step 76, the user applies the horseshoe onto the hoof. In some embodiments, it might be advantageous to press the shoe against the hoof for a pre-determined time period, one example being 40 seconds, to allow for surface curing. Next in step 77, the user activates the applicator to heat the horseshoe and/or adhesive to the cure temperature of the adhesive composition. The instant invention ensures that the shoe and/or adhesive are heated from an ambient temperature to the cure or degradation temperature of an adhesive system. Consequently, the instant invention is applicable to any adhesive system which is heat curable, including but not limited to one-part epoxies. In step 78, the horseshoe is bonded to the hoof as the adhesive cures because of the applied heat. And in step 80, the horseshoe is released from the applicator by opening or separating the jaws and/or brackets.

The detachment method could include steps 72-74, 77, 78, and 79. In step 72, the user places a horseshoe onto one of the applicators described above. In some embodiments, the user could adjust the inductive element in step 73 when the inductive element is flexible or of a non-rigid construction. It is likewise possible for the user in some embodiments to secure the horseshoe in step 74 to an applicator via brackets, jaws or the like. Further, the user can adjust the mounting structure to the size and shape of a horseshoe. Next in step 77, the user activates the applicator to heat the horseshoe and/or adhesive to the degradation temperature of the adhesive. In step 78, the horseshoe is de-bonded from the hoof as the adhesive degrades because of the applied heat. And in step 79, the horseshoe is pulled from away from the hoof and later separated from the applicator.

The description above indicates that a great degree of flexibility is offered in terms of the instant invention. Although devices and methods have been described in considerable detail with reference to certain preferred versions thereof, other versions are possible. Therefore, the spirit and scope of the appended claims should not be limited to the description of the preferred versions contained herein.

What is claimed is:

1. An apparatus for shoeing a horse comprising:
(a) an inductive heating element substantially U-shaped and disposed in a serpentine arrangement to replicate the U-shape of a horseshoe at least twice, said inductive heating element including one or more conductors;
(b) an adjustable mounting structure for supporting and securing said horseshoe adjacent to said inductive heating element, said adjustable mounting structure including a pair of jaws and/or a plurality of brackets which are separately movable along said adjustable mounting structure to conform to the lateral extents of said horseshoe, said brackets disposed in a substantially U-shaped pattern along said adjustable mounting structure, said adjustable mounting structure minimizing the coupling distance between said inductive heating element and said horseshoe; and
(c) a control circuit facilitating heating of said horseshoe and/or an adhesive by said inductive heating element.

2. The apparatus of claim 1, wherein said brackets contact said inductive heating element so as to adjust said inductive heating element to the shape and size of said horseshoe.

3. The apparatus of claim 2, wherein said inductive heating element passes through said brackets.

4. The apparatus of claim 1, wherein said inductive heating element is fluid cooled.

5. The apparatus of claim 1, wherein said inductive heating element is air cooled.

6. The apparatus of claim 1, wherein said control circuit heats said horseshoe and/or said adhesive to approximately the cure or degradation temperature of said adhesive.

7. The apparatus of claim 1, wherein said control circuit is time dependent.

8. The apparatus of claim 1, wherein said control circuit is temperature dependent.

9. The apparatus of claim 1, further comprising:
(d) a sensor which measures the temperature of said horseshoe and/or said adhesive.

10. A method for shoeing a horse comprising the steps of:
(a) placing a horseshoe onto an adjustable mounting structure, said adjustable mounting structure including a pair of jaws and/or a plurality of brackets which are separately movable along said adjustable mounting structure to conform to the lateral extents of said horseshoe, said brackets disposed in a substantially U-shaped pattern along said adjustable mounting structure;
(b) adjusting said adjustable mounting structure to the size and shape of said horseshoe;
(c) applying an adhesive onto said horseshoe and/or a hoof,
(d) applying said horseshoe onto said hoof; and
(e) heating said horseshoe and/or said adhesive via an inductive heating element, said inductive heating element substantially U-shaped and disposed in a serpentine arrangement to replicate the U-shape of said horseshoe at least twice, said inductive heating element including one or more conductors.

11. The method of claim 10, further comprising the steps of:
(f) adjusting said inductive heating element to approximate the shape and size of said horseshoe; and
(g) securing said horseshoe to said adjustable mounting structure.

12. The method of claim 10, further comprising the step of:
(f) releasing said horseshoe from said adjustable mounting structure.

13. The method of claim 10, further comprising the step of:
(f) pulling said horseshoe away from said hoof.

14. The method of claim 10, wherein said heating step bonds said horseshoe to said hoof.

15. The method of claim 10, wherein said heating step de-bonds said horseshoe from said hoof.

16. The method of claim 10, wherein said horseshoe is comprised of a metal, a plastic, and/or a composite.

17. The method of claim 10, wherein said adhesive includes metal particulates.

18. The method of claim 10, wherein said adhesive is an epoxy composition.

19. The method of claim 10, wherein said heating step is time or temperature dependent.

20. The method of claim 10, further comprising the step of:
(f) sensing the temperature of said horseshoe and/or said adhesive.
